(19) United States
(12) Patent Application Publication
(10) Pub. No.: US 2002/0022403 A1
(43) Pub. Date: Feb. 21, 2002

(54) CONNECTORS FOR AN ELETROSTATIC CHUCK

(76) Inventors: WING L. CHENG, SUNNYVALE, CA (US); DENNIS S. GRIMARD, ANN ARBOR, MI (US); SENH THACH, UNION CITY, CA (US); CHENG-HSIUNG TSAI, CUPERTINO, CA (US); ASHOK K. DAS, SUNNYVALE, CA (US); VIJAY D. PARKHE, SUNNYVALE, CA (US)

Correspondence Address: PATENT COUNCEL, APPLIED MATERIALS INC, 3050 BOWERS AVENUE, PO BOX 450A, SANTA CLARA, CA, 95052

(21) Appl. No.: 09/370,651

(22) Filed: Aug. 6, 1999

(51) Int. Cl. H01R 13/40

(52) U.S. Cl. 439/625

(57) ABSTRACT

Apparatus for connecting a first component to a second component in that the first component has a first connecting member attached thereto, the second component has a second connecting member attached thereto and either of the first or second connecting members is provided with a relief. The apparatus is a connector, the first component is a power supply and the second component is an electrostatic chuck. The first connecting member has a bore provided on a top end. The second connecting member has a threaded opening for receiving the first connecting member. Alternately, the second connecting member is provided with a groove disposed radially outward of the threaded opening. The connecting members provided with the reliefs accommodate and withstand the forces exerted thereupon caused by thermal expansion during semiconductor wafer processing.

### BACKGROUND OF THE DISCLOSURE

1. Field of the Invention

The present invention relates to electrostatic chucks for retaining a semiconductor wafer during semiconductor wafer processing in a process system, and more particularly, to connectors for connecting DC chucking voltage and RF biasing power to an electrode disposed within a chuck.

2. Description of the Background Art

Numerous electrostatic chucks are known in the art for retaining a semiconductor wafer within a process chamber of a semiconductor wafer processing system. A semiconductor wafer processing system is disclosed in U.S. Pat. No. 4,842,683 entitled “Magnetic Field-Enhanced Plasma Etch Reactor” to David Cheng et al, issued Jun. 27, 1989 and assigned to the same assignee as the present invention; this patent is incorporated by reference as if fully reproduced herein. Chucks such as those described above are made with connecting members (i.e., for connecting power supplies to various electrodes in the chuck) already attached. These connecting members extend from the backside surface and subsequently are damaged during shipping or installation into a process chamber.

To address the problem of the damaged connecting members and chucks, an electrostatic chuck 100 illustrated diagrammatically in FIG. 1 is presented. Such chuck 100 is described in detail in U.S. patent application Ser. No. 09/212,000 filed Dec. 14, 1998 and is herein incorporated by reference. Chuck 100 includes a chuck body 102 of ceramic material (e.g., aluminum nitride) and further includes an electrode 104 disposed within (i.e., embedded) in the chuck body 102. The embedded electrode is, for example, a molybdenum mesh electrode. The electrode 104 is coupled to a power supply (not shown) via a connector 106. The connector 106 includes a first, male connector member 108 and a second, female connector member 110. The chuck 100 is attached to a cooling plate 112 suitably mounted to the bottom of the chuck body 102 such as, for example, by a suitable adhesive or bolts (not shown). The cooling plate 112 may be made, for example, of stainless steel or aluminum and may be provided with a plurality of cooling channels 114 for carrying liquid coolant for cooling the chuck 100.

The first connector member 108 includes an upper solid cylindrical portion 116 extending through a bore 118 formed in the second connector member 110 and an integrally formed lower solid cylindrical portion 120 extending through a bore 122 formed in the cooling plate 112. The bore 118 and upper portion 116 are provided with female and male thread orientations respectively so as to facilitate connection of these components yet allow for rapid assembly and disassembly for shipping and installation purposes. The second connector member 110 is disposed within an inwardly extending, stepped cylindrical bore 124 in the chuck body 102. The electrode 104 contacts the second connector member 110 via the stepped cylindrical bore 124. A body of suitable electrically conductive adhesive 126 mechanically and electrically interconnects the top of the second connector member 110 and the electrode 104. As such, the first and second connector members, 108 and 110 respectively, mechanically and electrically interconnect the electrode 104 to the power supply (not shown).

The second connector member 110 is usually fabricated of molybdenum and is suitably plated with an electrically conductive material such as gold, silver or nickel for RF current conduction. The first connector member 108 is usually fabricated from stainless steel or titanium plated with an electrically conductive material such as gold, silver or nickel for RF current conduction. An RF gasket 128 is provided where these two components meet so as to improve RF current conduction between the first connector member 108 and the second connector member 110. However, a certain amount of heat is developed during the transfer of power from the power supply to the first and second connector members and to the electrode 104. Additionally, the processes at which the chuck is operated is usually in the range of approximately 350-400° C. At these elevated temperatures, thermal expansion of the first and second connector members creates considerable stresses upon these components which can cause breakage of the second connector member 110 and/or the chuck body 102. More specifically, molybdenum (of which the second connector member is fabricated), has an expansion rate of about 5 ppm/° C. and stainless steel and titanium (of which the first connector member is fabricated), have expansion rates of about 9 and 8.6 ppm/° C. respectively which are considerably higher. As such, the first connector member expands to a much greater extent than the second connector member. Since both connectors are solid, the likelihood of thermally induced forces contributing to failure of these components is substantial.

The critical area of failure of the first and second connector members is at the threaded portions of the bore 118 and upper portion 116. As thermal expansion of the connector members increases, cracks develop along the threaded portion of the second connector member 110. FIG. 5 depicts a stress scan of the first and second connector members 106 and 110 respectively in profile. Stress is measured in units of Mpascals (Mpa) with each level of stress assigned a particular greytone for a first connector fabricated from titanium and a second connector member fabricated of molybdenum at 400° C. It is readily seen that the different thermal expansion rates create stress differentials (denoted by the closely spaced regions of different greytones) at the critical thread contact points 502.

Therefore, a need exists in the art for an improved design in electrostatic chuck power connectors that reduces the likelihood of failure because of thermal stresses associated with such connectors.

### SUMMARY OF THE INVENTION

The disadvantages heretofore associated with the prior art are overcome by the present invention of an apparatus for connecting a first component to a second component in that the first component has a first connecting member attached thereto, the second component has a second connecting member attached thereto and either of the first or second connecting members is provided with a relief. The apparatus is a connector, the first component is a power supply and the second component is an electrostatic chuck. The first connecting member is for example an RF pin connected to one or more other connecting hardware for connection to a power supply. Such a pin has a bore provided on a top end. The second connecting member is for example a boss mounted into the electrostatic chuck. The boss has a threaded opening for receiving the pin. Additionally, the boss is provided with a groove disposed radially outward of the threaded opening. The first connecting member may be stainless steel, titanium, Kovar or other similar thermally non-conducting materials. The second connecting member may be molybdenum or other similar electrically and thermally conducting materials.

The connecting members provided with the reliefs accommodate and withstand the forces exerted thereupon caused by thermal expansion during semiconductor wafer processing. As such, the likelihood of cracking, breakage, arcing or otherwise failure of the electrostatic chuck incorporating the improved connector is substantially reduced.

### BRIEF DESCRIPTION OF THE DRAWINGS

The teachings of the present invention can be readily understood by considering the following detailed description in conjunction with the accompanying drawings, in which:

FIG. 1 depicts a partial, cross-sectional view of a prior art electrostatic chuck and connector assembly;

FIG. 2 depicts a partial, cross-sectional view of an electrostatic chuck having an improved connector assembly in accordance with the present invention;

FIG. 3 depicts a partial, cross-sectional view of an electrostatic chuck having a second embodiment of the subject invention;

FIG. 4A depicts a top view of a component of the subject invention as seen along lines 4-4 of FIG. 3;

FIG. 4B depicts a top view of a second embodiment of the component as seen along lines 4-4 of FIG. 3;

FIG. 5 depicts a stress scan of prior art electrostatic chuck connectors; and

FIG. 6 depicts a stress scan of electrostatic chuck connectors in accordance with the subject invention.

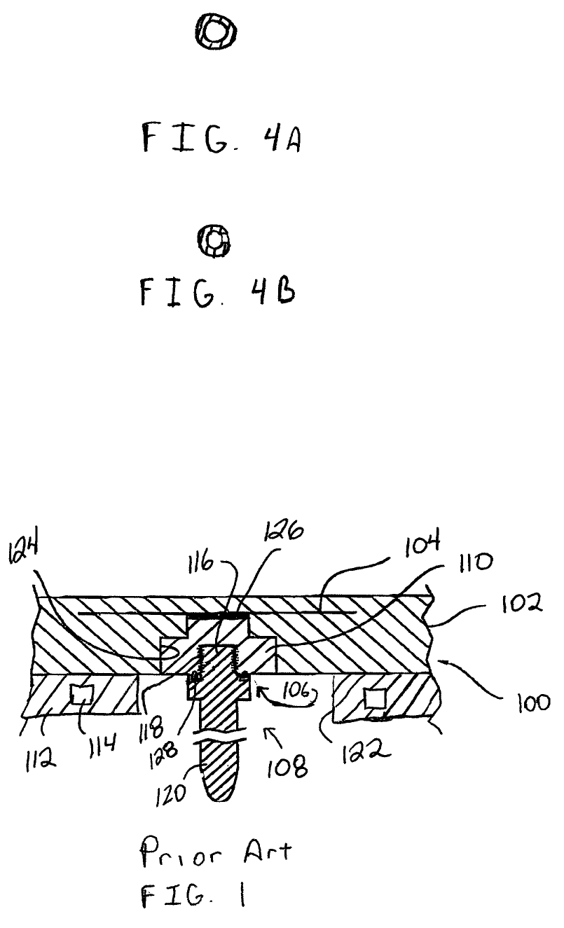

To facilitate understanding, identical reference numerals have been used, where possible, to designate identical elements that are common to the figures.

### DETAILED DESCRIPTION

FIG. 2 depicts a first embodiment of a semiconductor wafer electrostatic chuck 200 embodying the present invention. Chuck 200 includes a chuck body 202 in which an electrode 204 is embedded. The chuck body 202 may be made of a suitable ceramic material such as aluminum nitride, and electrode 204 may be a molybdenum mesh electrode. The chuck body 202 additionally has a chuck bottom 228 and a chuck top 230. The chuck 200 is attached to a cooling plate 222 suitably mounted to the bottom of the chuck body 202 such as, for example, by a suitable adhesive or bolts (not shown). The cooling plate 222 may be made, for example, of stainless steel or aluminum and may be provided with a plurality of cooling channels 232 for carrying liquid coolant for cooling the chuck 200. The chuck 200 further includes a connector 206 embodying the present invention and for connecting DC chucking voltage and/or RF biasing power to the electrode 204.

Connector 206 includes a first connector member 208 and a second connector member 210. Both the first connector member 208 and second connector member 210 are generally cylindrical in shape. The first connector member 208 is made of a material that is suitable for RF current conduction but does not readily transfer heat. Preferably, the first connector member 208 is stainless steel and may be plated with a suitable plating material chosen from a group consisting of gold, silver, nickel and copper to further enhance RF conduction properties and protect the first connector member 208 from corrosion. Alternatively, the plating material may be successive layers of nickel, copper, nickel and gold. Additionally, any type of RF conducting material may be used to fabricate the first connector member 208 depending upon the specific requirements of the application and in some instances stainless steel is replaced with materials selected from the group consisting of titanium and Kovar.

The second connector member 210 is also made of materials suitable for RF current conduction and is preferably molybdenum. The second connector member 210 resides in a blind bore 224 formed generally centrally of the chuck body 202 and extending upwardly from the chuck bottom 228 toward the chuck top 230 and opening to the embedded electrode 204. The bore 224 is cylindrically shaped and possibly further having a stepped configuration. The second connector member 210 is secured to the chuck body 202 by any means known to those in the art and is preferably secured by brazing. Additionally, a body of suitable electrically conductive adhesive 226 mechanically and electrically interconnects the second connector member 210 and the electrode 204.

The first connector member 208 is further provided with a threaded portion 212. Likewise, the second connector member 210 is provided with a threaded portion 214. The threaded portion 212 of the first connector member 208 communicates with the threaded portion 214 of the second connector member 210 (i.e., in a male-female orientation) so as to firmly yet releasably interconnect these members. Additionally, an RF gasket 218 is disposed between the first connector member 208 and second connector member 210 so as to improve RF current conduction. More specifically, the RF gasket 218 is disposed in a seat 220 on the first connector member 208. As threaded portions 212 and 214 engage one another, the gasket 218 is pulled into close communication with the members 208 and 210. Under the sometimes harsh process conditions (i.e., temperatures in the range of 350-400 C.) to which the chuck 200 is subject to, thermal stresses act upon the first connector member 208 and the second connector member 210 at their respective threaded portions 212 and 214. So as to not induce cracking, breakage or otherwise failure of the chuck 200, a relief is provided therein. Specifically, a groove 216 is provided in the second connector member 210. The groove 216 is disposed circumferentially about the threaded portion 214 of the second connector member 210. In such an embodiment, the groove is approximately 2-3 mm deep and approximately 1-2 mm wide. As such, a certain amount of thermal expansion is accommodated in that as the first connector member 208 expands, the groove 216 allows space for the expansion without exerting additional thermal stress on the remaining portion of the second connector member 210 or the chuck body 202.

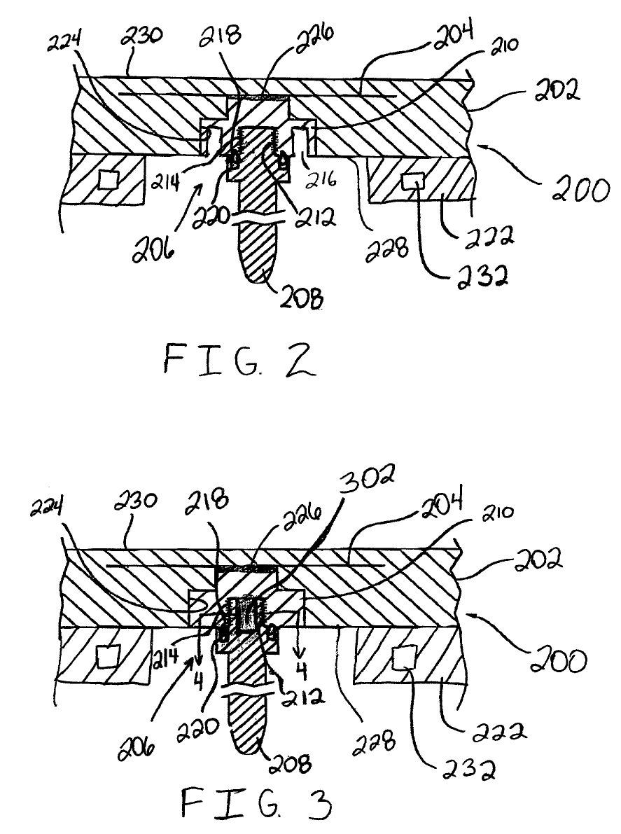

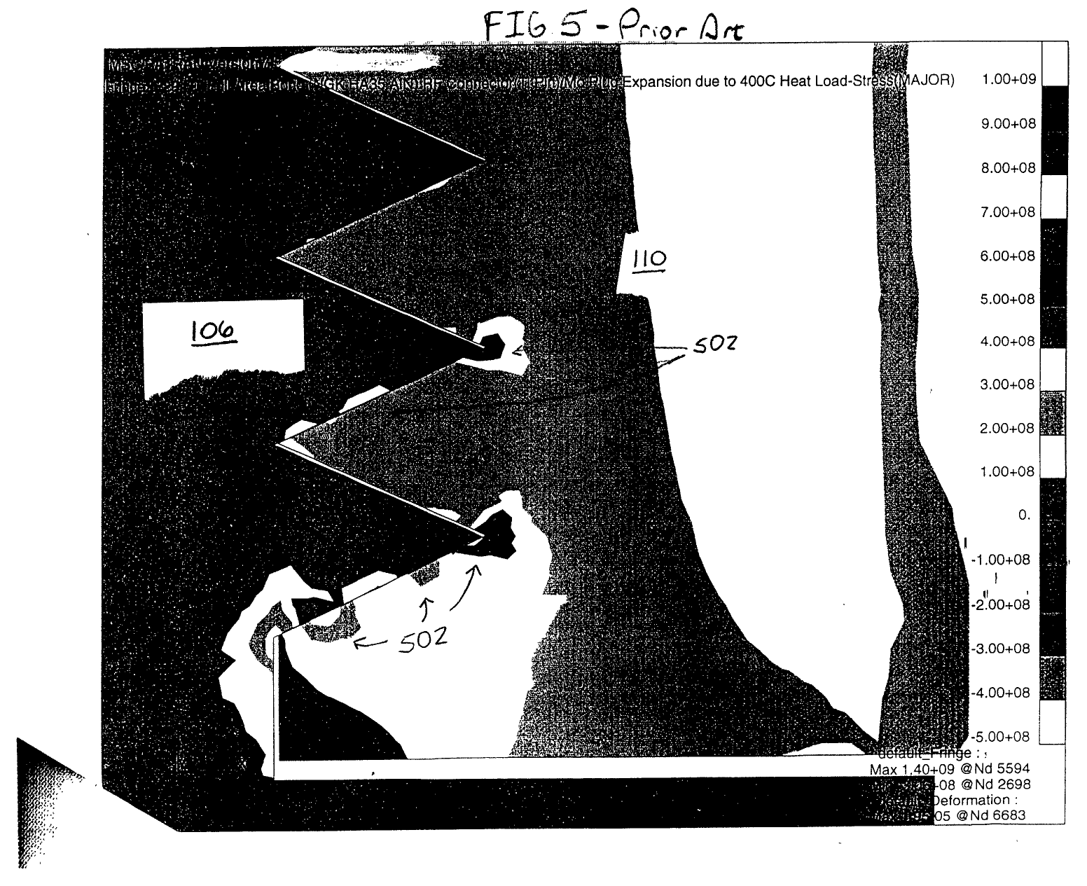

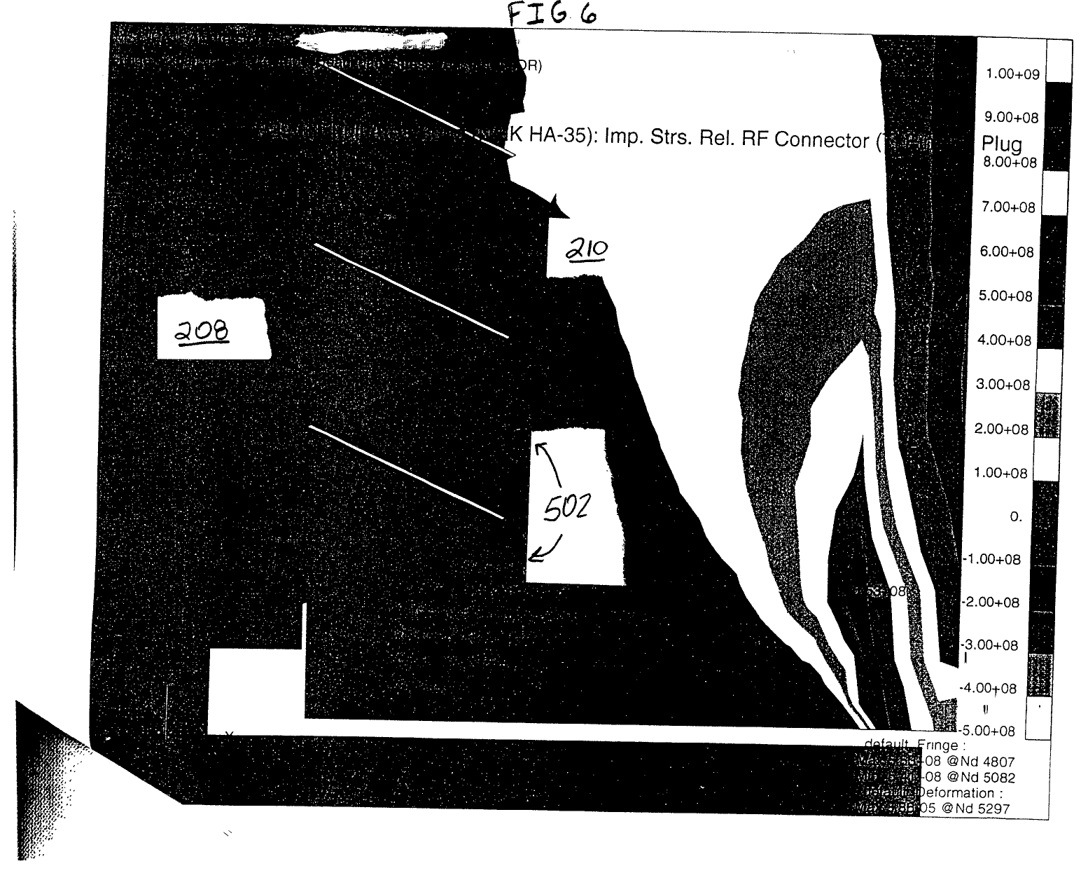

In an alternate embodiment of the invention depicted in FIG. 3, an electrostatic chuck 200 having all the required elements as discussed with respect to FIG. 2 is provided. Thermal stresses acting upon the threaded portions 212 and 214 of the first and second connector members 208 and 210 respectively of the connector 206 is again accounted for via a relief. Specifically, the relief is provided in the first connector member 208 as a bore 302. The bore is formed axially through the first connector member 208. Preferably, the bore 302 is approximately 1-2 mm in diameter below the threads and approximately 3-5 mm deep. With the configuration of the second embodiment seen in FIG. 3, much of the thermal expansion of the first connector member 208 occurs in a radially inward direction. That is, expansion occurs mainly into the bore 302 instead of radially outward towards the second connector member 210. As such, the thermal stresses applied to the second connector member 210 are substantially reduced and resultantly so is the possibility of thermally induced damage to these components. The bore 302 can have a variety of configurations such as the sole circular opening provided axially through the first connector member 208 as described above. FIG. 4A depicts a top view of the described embodiment when viewed along lines 4-4 of FIG. 3. Alternately, the relief can be further provided with a section removed from the first connector member 208 radially outward so as to form a “C” shaped pin when viewed from above. Such an embodiment is viewed in FIG. 4B. One skilled in the art can readily design and fabricate other similar type reliefs in either the first or second connector members having different shapes, such as a rectangular first connector with circular reliefs provides therethrough and the like. Such other designs are considered within the scope of the subject invention of providing a relief in a connector to account for thermal expansion and resultant stress.

The results of the improved connector 206 are seen in FIG. 6 which depicts a stress scan of a titanium-based first connector member 208 and a molybdenum-based second connector member 210 at 400° C. and having a relief in the form of bore 302 (not seen) in FIG. 6. Both components are near or at the same stress level (indicated by the same greytone levels) at the critical thread contact points 502. Some stress differentials are seen radially outward at the second connector member 210. However, these levels are evenly spaced and cover relatively large areas denoting an acceptable stress scan profile of these components. As such, thermal stresses are accommodated for and the likelihood of connector failure caused by same is greatly reduced.

Although various embodiments which incorporate the teachings of the present invention have been shown and described in detail herein, those skilled in the art can readily devise many other varied embodiments that still incorporate these teachings.

What is claimed is:

1. Apparatus for connecting a first component to a second component comprising:
a first connector associated with said first component; and
a second connector associated with said second component wherein one of said first and second connectors is provided with a relief.

2. The apparatus of claim 1 wherein said second component is an electrostatic chuck.

3. The apparatus of claim 1 wherein said first connector is a cylindrical shaped member.

4. The apparatus of claim 3 wherein said relief is a bore disposed within said first connector.

5. The apparatus of claim 4 wherein said bore extends approximately 3-5 mm into said first connector.

6. The apparatus of claim 4 wherein said first connector is C-shaped in cross section.

7. The apparatus of claim 1 wherein said first connector is a pin for connection of the second component to a power source.

8. The apparatus of claim 1 wherein said first connector is selected from thermally non-conducting materials.

9. The apparatus of claim 8 wherein said first connector is selected from the group consisting of stainless steel and titanium.

10. The apparatus of claim 1 wherein the second connector is disposed within said second component.

11. The apparatus of claim 1 wherein the second connector is a cylindrically shaped member having an opening.

12. The apparatus of claim 11 wherein said relief is a groove circumscribing said opening.

13. The apparatus of claim 12 wherein said groove is approximately 2-3 mm deep.

14. The apparatus of claim 10 wherein said second connector is a boss for receiving said first connector.

15. The apparatus of claim 14 wherein said second connector is fabricated of molybdenum.

16. An apparatus for electrically connecting an electrostatic chuck to a power supply comprising:
a first power supply connector; and
a second electrostatic chuck connector wherein one of said first and second connectors is provided with a relief.

17. The apparatus of claim 16 wherein said relief is a bore provided in said first connector.

18. The apparatus of claim 16 wherein said first connector is further fabricated from titanium.

19. The apparatus of claim 16 wherein said relief is a groove formed in said second connector.

20. The apparatus of claim 16 wherein said second connector is further fabricated from molybdenum.

21. The apparatus of claim 19 wherein said groove is disposed radially outward of an opening for receiving said first connector.
